(19) United States
(12) Patent Application Publication
(10) Pub. No.: US 2013/0054200 A1
(43) Pub. Date: Feb. 28, 2013

(54) Resilient Design Method for Improved Safety and Security of Structural Systems

(71) Applicant: Sena Kumarasena, Wellesley, MA (US)

(72) Inventor: Sena Kumarasena, Wellesley, MA (US)

(21) Appl. No.: 13/697,023

(22) PCT Filed: May 10, 2011
(86) PCT No.: PCT/US11/35896

§ 371 Date: Nov. 9, 2012

Related U.S. Application Data
(60) Provisional application No. 61/333,084, filed on May 10, 2010.

(51) Int. Cl. G06F 17/50

(52) U.S. Cl. 703/1

(57) ABSTRACT

In a resilient design method, input from a user (and possibly from a knowledge base and prototype designs) is accepted to establish functional, geometric and load criteria for a multi-hazard resilient design structure. A structure system design is then generated that satisfies those functional, geometric and load criteria. Various damage events are then simulated, wherein the load-bearing capacity (integrity) of members in the structure are compromised, and the redistribution of loads across members in the damaged structure and the structure stability is evaluated. The structure design is then reconfigured based on that evaluation to improve its structural stability and residual strength. These steps are iteratively repeated to incrementally improve the structural stability and residual strength of the structure across a variety of potential damage events; and a resilient structure can then be built in accord with the resulting design.

### BACKGROUND

Accepted norms of structural design based on engineering methods and mechanics, irrespective of their level of sophistication, account for two central issues. These two issues of fundamental significance are serviceability and safety and must be addressed in all engineered structures. The classical allowable stress design aimed at ensuring satisfaction of both of these objectives by keeping service stresses in structural components and their connections within the structure below the corresponding material strengths by a certain factor of safety. This approach worked well for early structures where the structural design was governed by relatively deterministic service loads such as dead loads, live loads and anticipated environmental loads based on historical records.

Modern day structures, however, are more sensitive to environmental loads that are best described in probabilistic terms. Even such parameters as material strength and dimensional tolerances are not truly constants and cannot be precisely known, prescribed or controlled during the design process. Probability-based limit-state design philosophies, such as the load and resistance factor design approach, which has gained universal acceptance as a rational design method, consider the loads as well as the strength of a structural member as probabilistic variables. This design method attempts to ensure safety by setting probabilistically calibrated design parameters called load and resistance factors with the intent of keeping the anticipated probability of the level of loading on a structural member during its service life exceeding its anticipated strength; in other words, failure, stays below acceptable norms. However, this design approach of member by member verification, by itself, has several drawbacks with respect to ensuring user safety and security.

First, the vast majority of sudden structural failures resulting in disastrous consequences are not due to adverse load combinations acting on the structure driven by chance (or probability) producing demand levels that cannot be sustained by the strength of a given structural member. Rather many of them are due to local (or global) conditions that were different from those anticipated during the design process. Global failure is precipitated, more often than not, by the failure of local element(s) leading to a condition that either lead to structural system instability or lead to a chain of progressive failure, typically conditions not specifically considered or anticipated during the design of the structural system. In fact, these failure mechanisms are not effectively mitigated by increasing member structural strength.

Second, existing design methods stop at making the probability of local member or component failures very unlikely when exposed to the known or anticipated conditions considered in design providing the structural system has not deviated from that assumed in design due to such factors as aging, or other deterioration or damage. The existing design methods do not specifically address the consequences of such occurrences as member or component failures that can occur in countless locations in a variety of manners precipitated by a number of different causes. However, this is truly the measurable parameter with respect to safety and security of a given structure. Thus it can be summed that the existing design approach needs some augmentation if the level of structural safety and user security are to be significantly enhanced and elevated beyond those realized at the present time. This is especially the case given the vast variability of potential conditions that could breach structural safety and user security that are not likely to be conceived, addressed or even known at the time of design. This deficiency leaves the safety and security of a given structure in service neither truly known nor reliably quantifiable even when they have been designed properly according to current, accepted norms.

Third, it is not likely that at least some of the conditions that could potentially overload and/or damage a given structural member or a component can be prescribed, even in probabilistic terms, at the time of design. This is especially the case with many of the significant landmark structures with relatively long expected useful life. These could be subjected to future conditions that simply cannot be anticipated due to incomplete knowledge or evolving conditions. In addition, such effects as accidental loading, willful sabotage, poor workmanship, material defects and other factors that may go undetected due to human error or a host of other factors. This evolving need for considering multiple-hazards including those that may not be known at the time of design brings some new challenges to the design of structures that require new approaches and new solutions for their effective mitigation.

Several cases of structural collapse, both historic and more recent, are shown in FIGS. 1-6. Specifically, FIGS. 1 and 2 show the Silver Bridge failure over the Ohio River in 1967; FIGS. 3 and 4 shows the Route I-90 tunnel ceiling collapse in Boston in 2006; and FIGS. 5 and 6 shows the collapse of Route I-35 over the Mississippi River in Minneapolis in 2007. The factors that led to these failures and the mechanics of failure are vastly different from one case to another. Important refinements to design considerations, fabrication, and construction and maintenance practices have resulted from each of the failure investigations to date, each addressing the uncovered cause precipitating the particular failure event with the aim of preventing similar failures in the future. Undoubtedly, these single-issue advances have generally been effective in reducing the number of subsequent failures brought about by the particular factor. However, these did not prevent the subsequent failure events from occurring as there are as many ways that local failures could precipitate as there are local components and varied conditions. The step-wise improvements to structural safety and security driven by lessons learned from failure events is a reactionary approach and likely to take many failures and consume a vast resources due to direct and indirect costs of the failure and all the forensic work involved. A more proactive approach is likely to enable reaching improved safety standards in a shorter time without the costs and the consequences of the reactionary approach.

The failure events shown in FIGS. 1-6 and many others share one simple commonality—small-scale local failures leading to general collapse, either by precipitating structural instability where the structure no longer can keep its geometric position or configuration or progressive collapse where failure of one member causes a chain reaction of failures. Both of these combined could be termed structural (or system) fragility. These local or component failures that precipitate overall failure are not effectively mitigated by increasing the design strength of structural members or components.

In a vast majority of cases, system fragility is the essential factor amplifying the local component failures to catastrophic structural collapse. While one could argue that prevention of factors contributing to the local failures could have prevented these particular incidences, strength-based design practices and tighter quality control alone cannot totally prevent such future incidences. The number of variables involved and the number of potential scenarios that could lead to local failures are just too many to be addressed specifically and completely to ensure that some future condition would not compromise their integrity.

The design procedures based on structural strength over anticipated loading demand at the member or element level should be supplemented with another system to ensure that the resulting structural system is devoid of fragilities and is both robust and reliable as a whole. Structural systems developed along the resilient design methodology outlined herein would assure such robustness and reliability by identifying fragile interdependencies within the structural system and helping in their elimination at a system level. A clear case in point is the I-90 tunnel ceiling support system where the actual load on the supporting components was reported to be only 10% of their strength and was explained to be quite safe. The false sense of safety in this demand over capacity or “factor of safety” likely clouded the decision making during design and implementation despite the seeming fragility of the system. The resilient design method being described would clearly outline these deficiencies and would help in their elimination.

FIGS. 1-6 show instances where small scale local failures had led to large scale structural collapse. In contrast, there are many bridges that have survived significant structural damage to the roadway elements as well as supporting elements that are clearly deemed sufficient to cause structural collapse. However, they have not only been able to absorb the damage without collapse as shown in FIGS. 7-10, but also have been able to maintain the functional geometry of the travelled roadway following large scale structural damage. Specifically, FIG. 7 shows a multi-girder concrete bridge in which all girders were damaged; FIG. 8 shows a superstructure cut-through in a concrete box girder following accidental impact; FIG. 9 shows a through-girder fracture in a three-girder bridge where all three girders were significantly damaged; and FIG. 10 shows pier damage and support loss in multi-girder steel bridge. It is highly unlikely that these bridges were originally designed with damage tolerance in mind, while the levels of the accidental damages they have suffered are clearly of a sufficient magnitude to expect structural collapse. However, their structural layout, geometric proportions, depth to span ratios and perhaps other yet unrecognized factors have enabled them to maintain global stability and residual capacity following these damage events.

Following various damage events that can be clearly deemed sufficient to have caused large-scale collapse, the latter group of structures exhibit considerable resilience against the particular structural damage inflicted, and continue to function in a way that protects the occupants or users of the facility at the time of the accident or damage. These occurrences, however, have received relatively little attention and study, likely due to successful performance being less newsworthy than bridge failures with devastating consequences. While the “resilient” aspects of the cases shown is likely the result of chance rather than any deliberate attempts during their design, and there is no guarantee that the same structures would exhibit resiliency against other types of damage; it is possible to develop structures by design that are endowed with general resiliency to structural damage.

### SUMMARY

A method for resilient design and a computer-readable medium storing software for performing the method are described herein. Various embodiments of the method may include some or all of the elements, features and steps described below.

In a resilient design method, input from a user is accepted to establish functional, geometric and load criteria for a structure. A structure system design is then generated that satisfies those functional, geometric and load criteria. Various damage events are then simulated, wherein the load-bearing capacity of members in the structure are compromised, and the redistribution of loads across members in the damaged structure and the structure stability is evaluated. The structure system design is then reconfigured based on that evaluation to improve its structural stability. These steps are iteratively repeated to incrementally improve the structural safety across a variety of potential damage events; and a resilient structure can then be built in accord with the resulting design.

The method steps can be encoded as software instructions stored on a computer-readable medium, and at least some of the steps in the method can be performed by a computer executing the software.

The resilient design methods described herein can help to prevent future structural failures by better accounting for the consequences of local failures, yet not needing specifically to address many factors that can cause local failures. This makes the process “blind” to various types of hazards that could precipitate local member or component failures, and being as such, it is capable of mitigating consequences of multiple-hazards both known and unknown.

The resilient design method makes a conscientious effort at improving the hazard resistances of elements and components using innovative applications of existing technology and confirmatory experimental testing. However, recognizing that element or component failures cannot be practically or cost effectively prevented in structures under all conceivable circumstances, these methods can nevertheless prevent general collapse of the structure following such damage events, thereby ensuring the safety of its users. By reliably engineering behavior into structures similar to the behavior depicted in FIGS. 7-10 under various credible damage scenarios in a practical, cost effective manner via these methods, the level of safety and security attainable in built infrastructure can be enhanced by an order of magnitude over that attainable through traditional design methods in use today. By the virtue that a number of varied local damage conditions are considered in developing the design, the resulting structure is multi-hazard resistant. This multi-hazard resistance is achieved through the implementation of the resilient design method described herein. The potential benefits and plausible improvements to safety and security that are within easily attainable reach are expected to be unprecedented.

Application of the described method can make system behavior similar to that shown in FIGS. 7-10, making resilient behavior considerably more prevalent when faced with the unpredictable reality of local or element damage, irrespective of the factors or the hazards causing such damage. As such, the resilient design methods described herein are blind to the type of hazard leading to the damage, and hence cable of producing structures that are multi-hazard resilient. The described resilient design approach can complement the traditional measures currently employed in the multi-hazard mitigation and can mitigate one of the key vulnerabilities of the traditional design process—conditions and events that are unknown, unforeseen, unexpected, undetected or conditions that can get overlooked.

### BRIEF DESCRIPTION OF THE DRAWINGS

In the accompanying drawings, like reference characters refer to the same or similar parts throughout the different views. The drawings are not necessarily to scale, emphasis instead being placed upon illustrating particular principles, discussed below.

FIGS. 1 and 2 are photographic images of the 1967 Silver Bridge failure.

FIGS. 3 and 4 are photographic images of the 20061-90 tunnel ceiling collapse.

FIGS. 5 and 6 are photographic images of the 2007 collapse of the 1-35 bridge over the Mississippi River.

FIG. 7 is a photographic image of an underpass where all girders in a multi-girder concrete bridge were damaged, though the structure survived.

FIG. 8 is a photographic image of a superstructure cut-through in a concrete box girder after accidental impact, though the structure survived.

FIG. 9 is a photographic image of a through-girder fracture in a three-girder bridge where all three girders were significantly damaged, though the structure survived.

FIG. 10 is a photographic image of pier damage and support loss in a multi-girder steel bridge, though the structure survived.

FIG. 11 is a sketch of a box-girder superstructure.

FIG. 12 is a sketch of an I-girder superstructure.

FIG. 13 is a sketch of a multi-girder steel composite superstructure of a cable-supported bridge.

FIG. 14 is a sketch of a segmental concrete superstructure of a cable-supported bridge.

FIG. 15 is a flow chart illustrating a resiliency analysis and interactive interface module working with a conventional analysis design process to yield a structural design that meets conventional design criteria as well as resiliency design criteria.

FIG. 16 is a sketch illustrating a conventionally designed structure including a bridge pier supporting a plurality of girders for meeting conventional design criteria.

FIG. 17 is a sketch illustrating the potential layout of a resilient-design structure including a bridge pier supporting a plurality of girders that the resiliency design methodology is likely to yield in lieu of the one depicted in FIG. 16.

FIG. 18 is a sketch illustrating an alternative design for a column in a structure subject to a damage event.

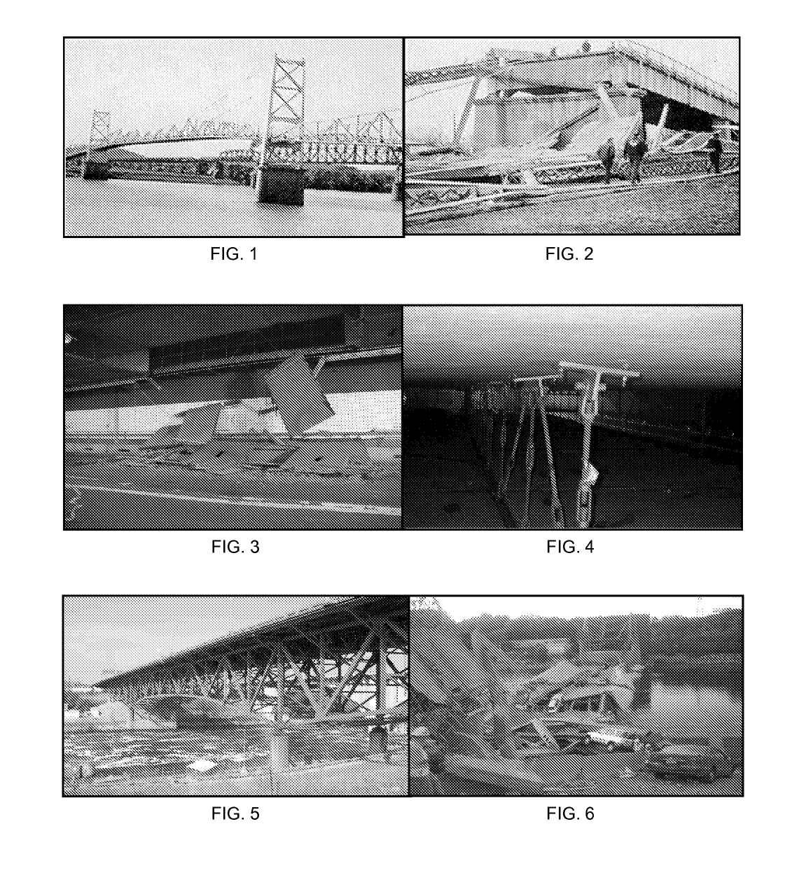

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise defined, used or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially, though not perfectly pure, as practical and imperfect realities may apply; e.g., the potential presence of at least trace impurities (e.g., at less than 1 or 2% by weight or volume) can be understood as being within the scope of the description; likewise, if a particular shape is referenced, the shape is intended to include imperfect variations from ideal shapes, e.g., due to machining tolerances.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “upper,” “beneath,” “below,” “lower,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to” or “coupled to” another element, it may be directly on, connected or coupled to the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

### Structural Safety & Multi-Hazard Mitigation:

While ensuring adequate structural strength will always remain a key parameter in ensuring safety and security of structures, there are several parameters other than just strength (or resistance against loads) that play critical roles in ensuring safety against factors that threaten the structural integrity, or, hazard mitigation. Some of the more traditional of these parameters critical to safety yet unrelated to the structural strength are listed, as follows.

A first hazard is wind instability, wherein a mitigating structural parameter is the cross-sectional shape of the structure. Long-span bridge wind instability is a function driven by the cross-sectional shape of a bridge deck. Some sectional shapes are capable of extracting energy from wind flow and go into oscillations of ever increasing amplitudes, eventually reaching self destruction. The most effective method for its mitigation is altering the shape of the structure seen by the wind-flow so that conditions driving instability are reduced or eliminated. A second mitigation method of increasing torsional stiffness of the superstructure is also a parameter independent of the design strength.

A second hazard is metal fatigue, wherein a mitigating structural parameter is tension-element redundancy. Metal fatigue is caused by crack propagation under service stresses, often of fairly low magnitude. A multi-pronged approach can be used to mitigate the hazard of metal fatigue, including not only measures taken in design but also detailing and fabrication, followed by inspection and maintenance during service. Despite all preventive steps, the unpredictability associated with real-life conditions of crack initiation and propagation remain. Providing redundancy with respect to all tension elements is considered the most effective and reliable risk mitigation method against fatigue. This is an example where not the amount (thus the strength) but the arrangement of structural capacity is the key to hazard mitigation

A third hazard is seismic activity, wherein a mitigating structural parameter is ductility. In seismic risk mitigation, ductile detailing is as critical, perhaps more critical to safety than the exact force levels considered in member design and the member strengths provided. The force-based member design alone has considerable limitations in terms of reliable, cost-effective mitigation of the seismic hazard. To ensure performance over a wider spectrum of conditions that may not have been specifically considered, ductility is provided within the structural system. Ductility mitigates seismic hazard risk by ensuring that the performance goals will be met at least approximately even when the level of ground shaking considerably exceeds those considered in design.

The number of hazards that must be considered in a meaningful multi-hazard risk mitigation include a considerably longer list of hazards than the above list of some of the more commonly recognized ones. The mix of multiple hazards that can be further considered includes wind; fatigue; corrosion; seismic; natural disasters, such as hurricanes, floods, and wave action; fire; blast loading; acts of terrorism and sabotage; construction and manufacturing defects; and factors such as lack of knowledge, human error, and negligence.

The resilient design methods, described herein, could be conceptualized as adding yet another system property, however with wide spectrum coverage (as opposed to single-issue system properties discussed before), which can be conceptualized and demonstrated as being the most practical and cost-effective approach to the mitigation of this relatively unquantifiable mix of diverse hazards. The term resiliency is used herein to describe this particular wide-spectrum system property infused into structures designed with the particular set of additional functional objectives described. Unlike the previously discussed system properties, such as redundancy, ductility, etc., structural resiliency is enabled through effective implementation of the described functional standards within the whole structural solution rather than into just one aspect of it or as a later addition.

In addition to being resistant to damage when exposed to a given hazard, this systemic resiliency design approach enables a structure to continue providing a certain minimum level of functional performance even when key structural elements are completely damaged. Thus, it provides a level of safety that is not specifically assured in the existing design methods (where minimizing the probability of component failure by providing sufficient member strength is deemed as the end measure of safety and security). The resiliency approach described herein would bridge the shortcomings of the existing strength-based design approach and provide reliable, cost effective multi-hazard risk mitigation where the nature and magnitude of hazards are not precisely predictable.

The resilient design method is a formal procedure that can produce structural systems that are first of all less likely to suffer damage under a given hazard event. Second, even if significant damage results from a hazard event of exceptional intensity, the resilient design method can infuse a certain inherent ability for maintaining global stability. Thirdly, structures designed with the resilient design method can, after suffering damage, continue to function, providing a level of performance that meets certain occupant safety requirements. These results can be achieved through the implementation of the following functional criteria in addition to other general design criteria and requirements commonly in use.

### Resilient Design Method—The Functional Criteria:

A first set of resiliency design criteria is targeted to improving member performance beyond those traditionally realized, wherein all structural members and elements are designed and detailed to ensure a set of minimum resistance criteria (such as a certain minimum surface pressure loading, a certain fire rating, impact resistance, and cutting resistance, where they are applicable and practical), in addition to the typical consideration of such criteria as redundancy and slenderness. Satisfaction of these criteria can ensure improved immunity to damage when the structure is exposed to a number of varied hazards. The application of such general member resistance criteria can result in improved structural member compositions, innovative application of new materials, and design and detailing concepts where inherent resistance to multiple hazard conditions are systematically enhanced, and hazard mitigation built in.

Existing member design methods do not consider a set of such minimum resistance criteria; and, as a result, a given structure may contain members that have no appreciable capacity for withstanding unforeseen loading and other conditions that could jeopardize the safety of the entire structure. The consideration of a set of minimum resistances in member design and detailing will improve the chances of member survival when exposed to a condition that was not specifically considered in design and will help mitigate member/component vulnerability.

These criteria on minimum member resistances in this first set are, while highly desirable, not essential to the resilience design method.

A second set of criteria is to ensure structural stability following structural damage scenarios considered. Certain structural element or component damage could result in a condition of either partial or global structural instability. The second set of criteria ensures that the structural system geometry selected is capable of maintaining its stability following all of the damage scenarios considered in developing the resilient design.

A third set of criteria ensures system residual capacity following damage. This system residual capacity is needed to ensure that the surviving members would have sufficient capacity for resisting effects of damage elsewhere so the structure can continue to carry the loads it had at the time of damage, and to eliminate the possibility of progressive collapse where members not directly affected by the original damage may fail due to insufficient capacity to do the same. This set of criteria ensures that all members of a given structural system are capable of having sufficient residual load-carrying capacity to resist the service loads with some factors of safety when a member or an element anywhere else in the system has suffered damage. This capacity is provided by identifying local damage scenarios during the structural system design and defining the service loads and the associated load factors that ensure structural safety in remaining members and elements under the various damaged states being considered. In addition to providing the ability to continue to carry the loads present at the time of damage, this capacity also mitigates the risk of progressive collapse following the initial structural damage by ensuring that the remaining members remain effective following initial damage and would have sufficient structural strength to resist the new demand levels with some minimum load factors established as adequate.

A fourth set of criteria is targeted toward limited system response following damage, which includes limiting deformations and limiting the dynamic response of the occupancy areas of the structure. This ensures that structural movements, accelerations and shock following the sudden damage is within tolerable levels to the occupants or users of the facility likely to be present at the time of damage.

As noted before, the first set of criteria on minimum member performances are intended to make the structural members more resistant to damage when exposed to multiple hazards, and therefore reduce the likelihood of the members suffering damage under a given hazard scenario; these member performance criteria are essentially service-level targets intended to reducing the probability of local or component damage. As such, they are desirable yet a subjective component of the resiliency design that should be established on a case-specific basis. The second, third and the fourth sets of criteria are most central to various embodiments of the resilient design method and represent safety-level targets.

### Implementation of the Resilient Design Method in the Context of a Bridge:

The following outlines a descriptive implementation of the resilient design method using a simple bridge structures for illustration. Bridges, by nature, offer relatively limited possibilities for variation of structural layout and framing configurations. Thus, bridges can be considered as a class of structures posing the hardest of challenges in formulating resilient designs and hence provides the best cases for illustration. The methods can alternatively be directed to the design of any of a wide variety of structures, including buildings (e.g., skyscrapers), vehicles (e.g., automobiles, ships, aircraft), dams, power plants (e.g., nuclear, gas, coal), retaining walls, etc.

The design process begins by defining the below-listed parameters in addition to other conventional design criteria and requirements. Some of these parameters may be considered on a structure-specific basis, considering not only the importance of the particular bridge to the transportation network but also the tangible and intangible consequences of its failure.

1) Multi-Hazards: identification of hazards important to the safety and security issues within the context of a given bridge or a transportation system.

2) Target Hazard Resistances: establishment of member performance standards with respect to the different hazards, such as minimum desired fire rating, surface pressures and impact loads to be sustained at element level without failure.

3) Member Composition and Detailing: development of structural member compositions that can meet the target hazard resistances established.

4) Hazard Mitigation Systems: special systems that would further improve member hazard resistances where needed; examples include dehumidification systems, sprinkler systems, special coatings and local applications of structural shields and other hardening measures.

5) Damage Scenarios: the multiple structural damage scenarios that are considered in design; they can be formulated to represent realistic conditions that can be expected but also keeping in mind that prevention of collapse under all scenarios is impractical. The selection of realistic damage scenarios and development of a global structural system that is capable of maintain structural stability under these damage scenarios goes hand-in-hand.

6) Service Loads: loads to be considered as present on the bridge at the time of damage, at a minimum, will include the self weight and expected live (occupancy) loads as a minimum. The requirements outlined in the National Cooperative Highway Research Program (NCHRP) Synthesis 406 for bridge superstructures redundancy can be shown to be approximately equivalent to requiring a residual resistance of at least 1.15 DL+1.08*(LL+I) where DL and LL+I represent the Dead load and Live Loads used in original design (S. Kumarasena, Quantitative Assessment of Structural Redundancy by Computer Modeling, Proceedings TRB, 2005). This makes intuitive sense as providing sufficient margins of safety against fatigue damage where the structural cracks or other types of minute or small scale distress may not be immediately visible and may not be detected and corrected for some considerable time. However, the damage scenarios considered for resiliency are of an easily noticeable magnitude and would result in immediate corrective action. Thus, reducing load factors used in resiliency analysis somewhat is deemed justifiable. The general form αDL+β*(LL+1) where 1.0<α<1.15 and 0.5<β<1.0 can be used where the parameter, β, should be selected on a structure-specific basis to represent typical heavy traffic in striped lanes.

7) Roadway Deflection Limits: roadway deflections and its time derivatives (velocity, acceleration, etc.) must be maintained sufficiently low to avoid unsafe occupancy conditions and/or panic amongst the bridge users present on the roadway at the time of structural damage. Roadway deflections (including the dynamic component) within 1 to 2% of the span length can be generally considered acceptable. In addition, structural deflections can be configured to not cause mutual impact of members and can be limited to a magnitude to enable potential repair of the bridge where possible.

Items 1 to 4 follow the first functional criteria (on member performance) discussed before, these constitute selection of member compositions, and design and detailing considerations for enhancing member hazard resistances (where practically possible and economically viable). Improvement of hazard resistances and implementation of mitigation systems are implemented at the member level. Evaluation of the hazard intensities to be resisted and systems to be implemented involves consideration of available technology as well as their cost effectiveness on a case by case basis.

A considerable improvement in this area is immediately achievable by combining conventional materials and systems technology that complement one another. One example is the use of concrete-filled hollow steel sections, where the combination of the two materials and how the member is detailed can be used not only to improve overall design efficiency and constructability but also improve blast and fire resistance considerably. Use of cross-sectional configurations that limit damage propagation through the cross section is another innovation that can yield immediate benefits. Such member cross sectional configurations that limit the damage propagation would be especially useful for application in large structural elements, such as tower and pier elements.

Considerable potential exists for exploring uses of newer advanced materials in supplementing those that are more conventionally used within the industry. These and other potential methods of improving member performance must be verified through numerical and field testing before they can be used in a qualitative manner.

Further, there are ample opportunities for using supplemental systems or combining many features in to one system for improved hazard resistance. For example, the use of de-humidification systems for suspension bridges cables is one such example, as these systems are currently gaining popularity in preventing wire ruptures due to corrosion. However, with multi-hazard thinking, such cable dehumidification systems can be easily combined with other systems, such as sprinkler systems, intumescing coatings, and elements that incorporate hardening for vulnerable areas. Applications of multi-hazard mitigation designed and coordinated as one system can potentially result in better cost and implementation efficiencies. As noted previously, however, the design of members and systems to withstand all hazards at all intensity levels is neither practical nor cost effective; and the member performance criteria, while highly desirable where such can be implemented cost effectively, is not essential to the resilient design method.

Items 5 to 6, follow the previously discussed second and third criteria—system stability and residual capacity following damage scenarios; and item 7 follows the previously discussed fourth set of functional criteria for limited system response of the facility occupancy areas following damage. In combination, the items 5, 6 and 7 form the safety level provisions or hazard risk mitigation; and they can ensure that the bridge (or other structure) continues to function following significant local damage, regardless of its cause, which is the central theme in embodiments of the resilient design method.

Thus, the implementation of the resilient design process follows the following design development process:

A) Resilient Global Structural Layout: the structural layout provides a stable system under various damage scenarios and continues to function at safety level, requiring the development of structural systems that can maintain stability after suffering significant local damage, which is a basic criterion for the design of resilient bridges. This layout is implemented at the conceptual stage and could be a practical impossibility or cost prohibitive if it was implemented as a latter addition. Selection of member compositions and member detailing that meets the established member performance goals can be an integral part of this development of the global structural layout.

B) Simulation of Damage Scenarios: this simulation involves the definition of various local damage scenarios to be considered and mathematical or numerical simulation of each of the damage scenarios. The simulation considers not only static, but also dynamic forces, as well as propagation and interaction effects of sudden damage within the structure laden with service loads.

C) Quantification of Effects: this quantification involves simulation of various damage scenarios on an analytical model pre-loaded with service loads. The simulation is capable of capturing the transient dynamic response following sudden structural damage as well as predicting any subsequent progressive failures of other members. Thus, the analysis is capable of capturing geometric non-linearity, material non-linearity and material failure, and is capable of working through a large number of multiple damage scenarios in a time-efficient manner and providing an interactive interface or other mechanism for the engineer developing the design and verifying that, in addition to the typical structural design criteria, the structure meets the project-specific or default thresholds for resiliency criteria being implemented.

The practical implementation of the above process involves a considerable amount of iterating through the above three task areas in an analysis environment that can facilitate designer interaction and formation of the solution. The execution of this analysis and quantification process for a real-life structure is believed to be both impractical and cost-prohibitive within the context of general-purpose analysis packages currently in existence.

Thus, the practical implementation includes software packages, modules or routines custom tailored for developing a resilient structural design and proofing that all of the functional criteria are met and for accepting designer interaction. These packages, modules or routines can blend and combine interaction with a knowledge base of parameters, prototype systems and other data, high-end analysis capabilities, data-reduction capabilities, interactive interface capabilities and automation capabilities to enable carrying out the resilient design process in a reliable, quantifiable manner suitable for practical implementation.

With the advantages of the resilient design method in improving the safety and security aspects established above, suitability of the resilient design method for wide-spread practical applications depends on the following three issues: technical feasibility (foremost), cost impacts, and whether any cost impacts can be justified based on its benefits. Several designs conceptualized by the inventor show that this is not only technically feasible but can be done cost effectively as well.

### Technical Feasibility, Practical Implementation, Cost & Benefits:

The following two examples apply the resilient design method (a) to simpler and more-typical girder-type bridges and (b) to the most complex cable or hanger supported bridge forms, where the additional functional criteria for resiliency can be satisfied without compromising the cost efficiency and, in many cases, improving such efficiencies.

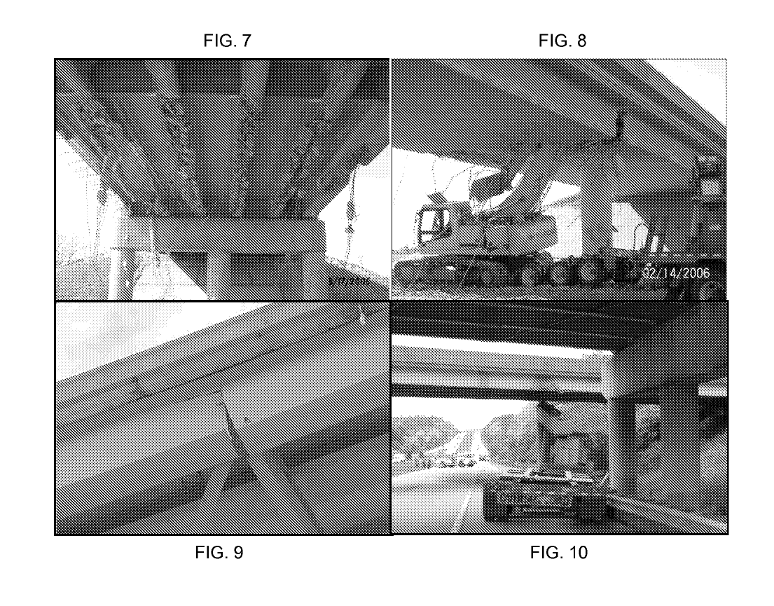

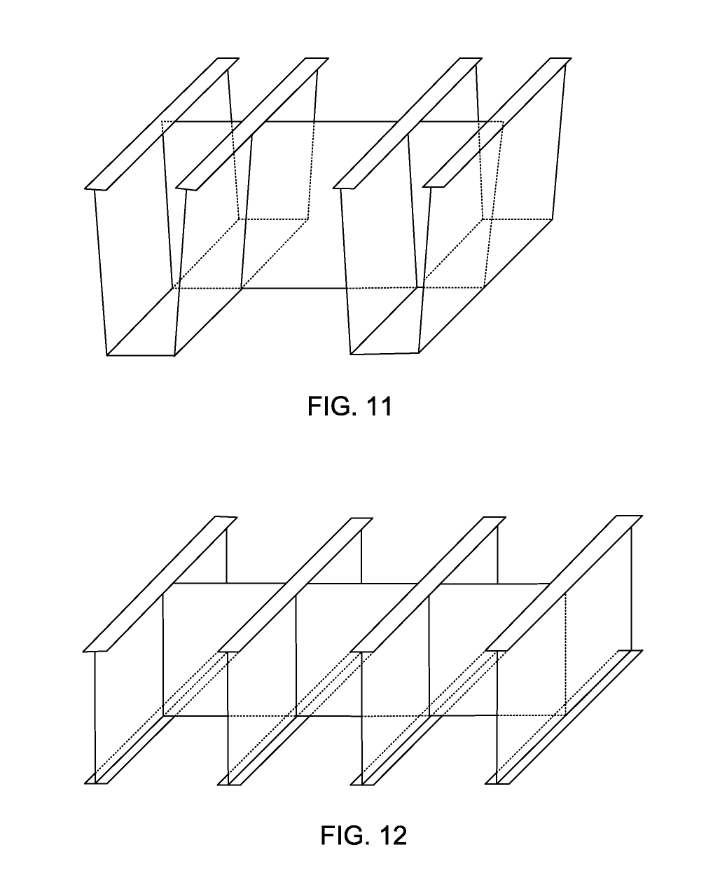

The structural framing of typical box girder and I-girder bridge superstructures are shown schematically in FIGS. 11 and 12, respectively. These structures can be steel composite or concrete. Use of the resilient design method can produce properly sized longitudinal girders and intermittent transverse framing, as schematically shown by the shaded planes and the connection requirements that enable resilient performance, similar to those shown for the structures of FIGS. 7-10.

While various types of transverse framing are being used in traditional detailing of bridges, the function they serve and the criteria followed in the design and detailing of these elements are very different from the requirements of the resilient design method.

Use of the resilient design method can yield systems that contain compatible solutions for longitudinal and transverse structural framing elements and connections that together are capable of meeting the functional criteria and damage tolerance discussed previously. For example, it can be shown through damage simulation analysis that a twin box girder bridge with intermittent transverse diaphragms, as shown in FIG. 11, can meet the safety level functional performance under complete damage to any one of the two box girders anywhere in the span and/or damage to the pier or other supporting elements.

While transverse diaphragms are incorporated into traditional designs for other reasons, mostly as secondary elements and in a few special cases as primary elements, the existing design criteria on these elements are not meant for their participation in the system in a manner compatible with the resilient design method. The transverse diaphragms between the boxes, provided intermittently over the span and their connections, for meeting the resilient design criteria must have the capacity to facilitate load redistribution from the failed box girder to the other box girder within a relatively limited portion of the span, and have sufficient stiffness to limit the response of the roadway following various damage scenarios. These capabilities, in turn, will ensure the bridge's ability to maintain global stability as well as its ability for carrying service loads with minimal deflections of the roadway slab even for a curved simple-span bridge where such a test may be seen as most challenging.

In addition, the design of the transverse framing elements in this manner results in considerable reduction in the design demand for the individual longitudinal girders and, as a result, it can be shown that there is a net reduction in the total quantity of construction material utilized. Thus, it can be surmised that the resilient design method described herein can result in a net cost saving for such bridges compared with those resulting from traditional design methods.

There are many complex, signature bridge forms that pose unique challenges. The arch and cable-supported long-span bridges contain many elements that, under present-day applications, cannot be practically or cost-effectively upgraded to meet resiliency criteria discussed herein. The consequences of significant damage to key elements, such as arch ribs, tie girders in tied arch structures, supporting piers, tower damage in cable-supported bridges, superstructure damage in cable-stayed bridges, main cable failure in suspension bridges, and multiple cable loss in cable-stayed bridges, are all matters largely of foregone conclusions.

However, resiliency in long-span signature bridges is achievable when developed with unique global structural systems that contain features such as arch ribs in certain geometric forms, certain cable/hanger arrangements, proper transverse load paths, compatible tower and/or bracing layouts, and proper member cross-section designs. The resilient design method and its knowledge base and the tools of analysis and automation enable the verification of such resilient bridge forms for long-span, specialty and signature bridges of all types.

For example, the multi-girder, multi-cable-plane bridge superstructure arrangements with properly designed transverse framing (shaded) similar to those schematically shown in FIG. 11 through 14 can be used as a basis of developing resilient cable-supported signature bridges. Such bridges when combined with appropriate tower and pier configurations can be designed to meet the functional criteria and damage tolerance criteria of the resilient design method presently discussed.

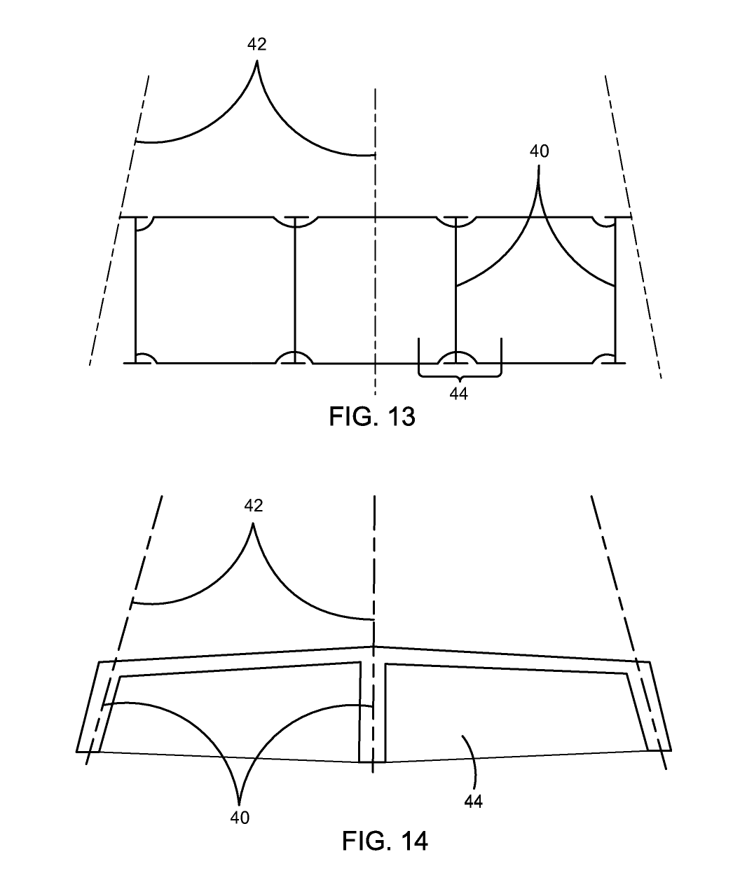

Schematic superstructure layouts for cable-supported bridge forms are shown in FIGS. 13 and 14. Specifically, FIG. 13 shows a multi-girder steel composite superstructure including steel girders 40, cable planes 42, and transverse framing 44, while FIG. 14 shows a cast-in-place or pre-cast segmental concrete superstructure. The layouts, positions and the number of cable planes, girder lines and transverse framing shown is schematic with the exception that typical cable supported bridge designs contain one or two cable planes and longitudinal main girder lines; the resilient cable supported bridge forms are likely to contain two or more cable plains and two or more main girder lines with transverse elements all designed as a system meeting the resiliency design criteria.

Again, due to structural efficiencies resulting from the increased level of load sharing and load distribution made feasible due to inherent properties of structural systems produced with the resilient design method, it can be shown that cost savings are possible due to improved efficiencies.

Practical implementation of the resilient design method involves the development of several entities. The first entity is a knowledge base. This knowledge base is a library of information including such information as various parameters necessary for the implementation of the resiliency design functional criteria, the data on member performance criteria (derived from condensation of existing literature, numerical modeling or laboratory testing of various innovative design options, discussed previously), lessons learned and rules derived from the structures suffering significant damage (as those shown in FIGS. 7-10), suggestive or prototype resilient structural systems and components for various structural forms that can be custom tailored by the user for a particular application, etc.

The second entity includes tools for analysis and automation; as described in more detail in the following sections, this entity will aid in the practical implementation of various embodiments of the resilient design method. A third entity is a collection of design examples that give worked examples for the user as a learning/verification tool. These examples can include prototype or suggestive designs that the user could follow. These design examples would articulate the implementation of these next-generation bridge forms that are inherently resilient to local damage. A forth entity is a user interaction platform where the above-noted entities and other entities needed for the implementation of the resiliency design are integrated and interfaced.

The most significant benefit of the resilient design method is that it can provide a systematic approach to improve multiple-hazard resistance within what can be practically and cost effectively accomplished with available technology. In addition, as complete damage to structural elements are assumed in proving the structure's ability to continue functioning following potential damage, functional performance under duress is less specific to the type of causative hazard. These capabilities can provide a superior approach to handling the new challenges faced in bridge security arena and the multi-hazards in mitigating risk of the unknowns and unanticipated. This has the potential to provide the most practical, cost-effective and reliable solution to a very difficult challenge of the day—multiple hazard risk mitigation. In many cases, an optimized system also is more structurally efficient than conventional designs, and the resilient designs are likely to result in cost savings or be cost neutral in many cases; and any increase in cost in some cases may be marginal or relatively small at the worst.

The resilient design method can reduce fragility in the designed structure. Examination of several recent large-scale structural failures with devastating consequences suggests that they were set off by small-scale component failures. Resilient designs have a very high level of immunity to such local failures, as the design process removes system fragility and provides a reliable, robust solution capable of mitigating such events.

There are other significant additional benefits from this approach. An additional benefit of the resilient design method is that it can reduce the risk of catastrophic failures due to events of very large intensity or magnitude that cannot be reasonably accommodated within the typical design process. The hardening or strengthening approach, by itself, leaves the structures vulnerable to events larger than those considered in the design. With the resilient designs method, safety does not rely on accurate quantification of the force effects, a task proven to be very difficult and unreliable for the high variability large magnitude hazard events. The ability of the structure to continue to function in a damaged condition is irrespective of the cause and the magnitude of the event.

Yet another benefit is that resilient designs do not typically lead to conflicts in mitigating different hazards where a solution for one may aggravate another. They are expected to complement other hazard mitigation measures in place to provide an even higher level of margin against various risk scenarios.

Furthermore, designs based on the resilient concept can not only provide essentially a no-cost solution to one of the most difficult and challenging problems of the day, but also reduce the future costs of maintenance and inspection. Resilient designs result in systems with more evenly distributed capacity within the structure; they are more amenable to optimization than traditional structural forms. Depending on designer skill, the process is likely to lead to more cost-efficient designs where the resulting structures are also more efficient, economical, and easier to construct. As they are also immune to small scale damage deterioration and imperfections, the time between successive inspection and maintenance cycles can be considerably lengthened. This would result in a considerable reduction in the resources spent on regular inspection and maintenance operations.

### Development Outline:

As noted before, the implementation of the resilient design method includes the development of a knowledge base, tools for analysis and automation and suggestive and prototype proven design examples of structural systems developed following the resilient design method. The descriptions of the knowledge base and the suggestive and prototype proven designs were discussed previously. The purpose, the expected capabilities and the architecture of the tools of analysis and automation is discussed below. The knowledge base and the suggestive and prototype designs could also be implemented as part of the package of the tools for analysis and automation.

### Tools for Analysis and Automation:

The practical implementation of the resilient design method to improve the safety and security aspects of structural systems involves tools (e.g., software tools) for analysis and automation. These tools allow the implementation of the resilient design method and additional functional criteria to further augment the traditional design method based on traditional design loads and member resistances. This resiliency analysis and interactive interface module can provide a platform for the following:

A) a knowledge base and/or data base, either stand alone or integrated with the resiliency module with information on implementing the resiliency design, such as:
establishing the parameters and data/knowledge base needed for resiliency analysis;
establishing performance goals for member hazard resistances, suggestive member layouts and compositions, results of numerical and laboratory testing of innovative member compositions and detailing as applicable;
establishing various local member and element damage scenarios to be considered for a given structure type; and

B) a resiliency module capable of:
performing multiple local damage scenarios on the structure loaded with service loads;
storing and sorting the structure response and member forces in surviving members following various local damage scenarios;
checking the acceptability of the structural response and stability following damage scenarios;
developing member capacity envelopes/requirements for surviving members to prevent progressive collapse;
interfacing with the various analysis modules, such as an approximate analysis module, a conventional analysis module and an enhanced (rigorous) analysis module; and
providing an interactive interface for evaluating options during the resilient design development process;
   for reliable results and effective implementation, the enhanced (rigorous) analysis module and/or the resiliency module could have the following capabilities in structural analysis, data storage, data reduction and interface capabilities combined:
integration with the user interface, knowledge/data base, approximate and conventional analysis modules;
large deflection and geometric nonlinear analysis capabilities;
full capabilities for material non-linearity as well as non-linear connectivity modeling;
composite behavior between different materials and material separation modeling;
member failure modeling—both initial sudden member removal as well as subsequent progressive failure of other members;
stability analysis of the deformed, damaged structure;
time domain non-linear transient dynamic analysis;
assembling envelopes of member capacity demands and structural response data and interfacing with conventional analysis to form combined demand and response envelopes;
visual or otherwise interactive interface (e.g., a computer display, mouse and keyboard) where problem areas are shown and member connectivity and other properties can be refined and suitably adjusted; and
material quantity summaries and cost evaluation/comparison capabilities;
   and

C) suggestive and prototype structural system layouts
developed as prototype designs with or without the aid of fully or partially developed knowledge base A) and the resiliency module B) and
proven as meeting resiliency requirements that can be adopted for a given structure type for specific functional and site conditions.

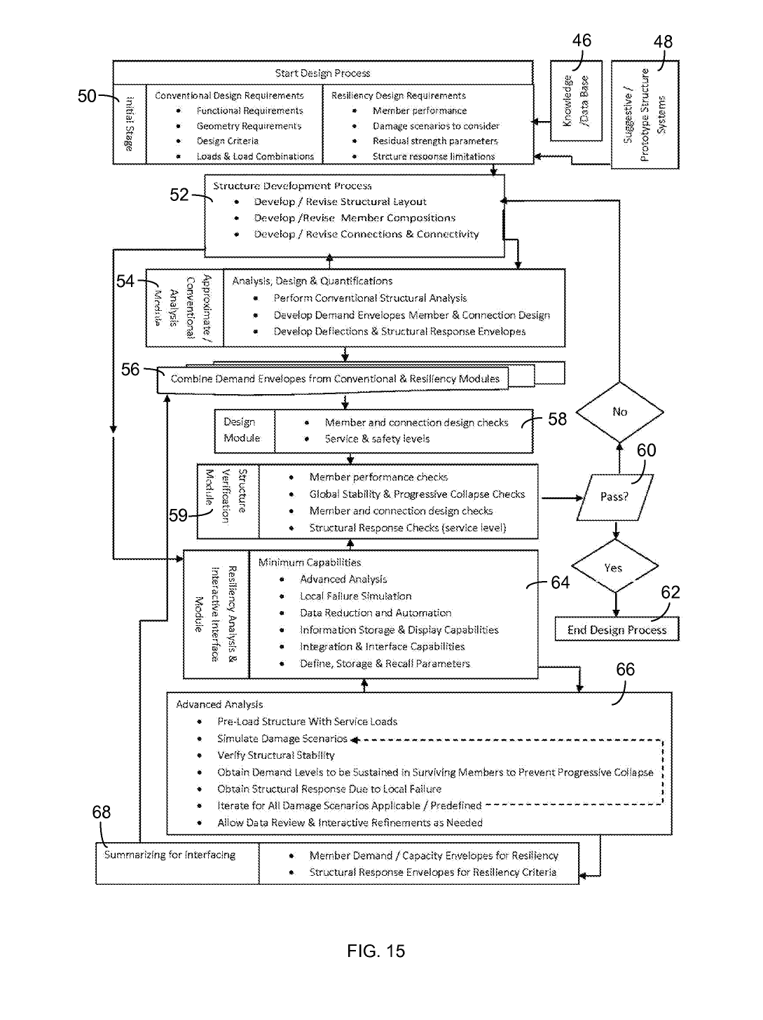

The flow-chart in FIG. 15 illustrates how the described interactive interface module can work with the traditional design process and the resiliency design process to produce a structural system that meets the traditional design requirements as well as the added requirements of structural resiliency described herein. The resilient design method begins with an initial stage 50, where conventional design requirements, such as functional requirements, basic geometry requirements, design criteria, and loads and load combinations, as well as the resiliency design goals, are entered into the computer and/or selected from the knowledge base. The user could also modify a suggestive or a prototype structural system from the knowledge base to suit the particular circumstances and use the supplementary data provided within the knowledge/data base in developing this initial layout.

Next is the initial structure development process 52, wherein the structural layout, member compositions, and connections and connectivity are developed to suit the particular requirements of the specific project, analyzed, evaluated revised and optimized by the computer with or without user input and user interaction. Next is an approximate/conventional analysis software module 54, where conventional analysis and/or approximate analysis and quantifications occur, such as
quantification and/or graphical display of the structural performance; and
the development of such parameters as envelopes or contours of structural strength demand vs. structural capacity of members and connections, both due to conventional analysis as well as resiliency analysis following simulation of a number of damage scenarios, information on structural demand vs. capacity of members and connections, and envelopes or contours of structural deflections and other structural response of the structure in general and in the user-occupied areas.
   This module 54 may interact with the knowledge/data base 46 and prototype layouts 48 as the module 54 iterates through with or without user input and manipulation in arriving at an initial structure layout that is expected to meet traditional as well as resiliency design requirements. In a series of steps 56, the summary envelopes/contours are combined from the conventional analysis module 54 and resiliency modules.

The structure thus developed/revised is then forwarded to a conventional design module 58 and to a resiliency analysis module 64 where it will be analyzed, evaluated and updated to meet the criteria on both fronts. The results from these are sent to the structure verification module 59.

The software then instructs the computer to perform structure verification 59, which includes checks of global structural stability and progressive collapse, member and connection design (for service and safety level), and structural response (service level). If the structure verification 58 successfully passes 60 the design, the design process can end 62. If the structure verification 58 fails to pass 60 the design, the process returns to the structure development process 52 for further iteration.

The minimum capabilities for the resiliency analysis and interactive interface software module 64 includes: advanced analysis; local failure simulation; data reduction and automation; information storage and display capabilities; integration and interface capabilities; definition, storage and recall of parameters, and economic comparisons.

The advanced analysis for the resiliency design method may be either built into the module 64 or provided in a separate advanced analysis module 66. Performing this advanced analysis under either scenario, the latest designed version of the structure is pre-loaded, via simulation, with service loads and damage scenarios are simulated. The structural stability after simulated exposure to each damage scenario is verified, and the demand levels to be sustained in surviving members to prevent progressive collapse are obtained. The structural response to local failure is also obtained, and this process simulation is iteratively repeated for each damage scenario. The software then allows for data review and interactive refinements, as needed.

The resiliency analysis module 66 then interacts with module 68 for summarizing the analysis/design information from the latest iteration for interfacing. The results summarized may include member demand and capacity envelopes or contours, for checking standard design requirements and resiliency criteria, structural response envelopes or contours for checking against resiliency criteria, and these envelopes are fed back to combine 56 to continue the process of iterative refinements and/or verification of the final structural layout as satisfying both tradition resign requirements as well as resiliency design requirements.

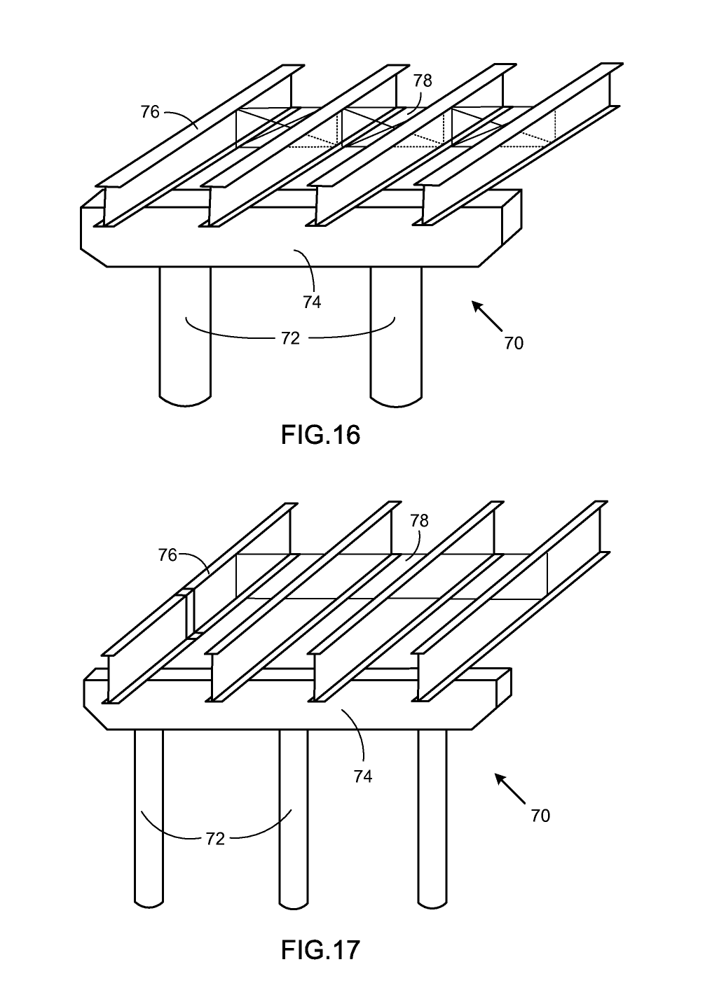

FIGS. 16 and 17 provide schematic illustrations showing how the process can transform a structural layout and design that meets the conventional design criteria (FIG. 16) into one that meets both conventional as well as resiliency design criteria (FIG. 17).

In the example of FIG. 16, a two-column bridge pier 70 is designed to meet the conventional structural demands including any impact forces to be resisted by the pier columns 72 or the pier cap 74. The design, however, does not account for the condition where one of the columns 72 may suffer damage or be effectively be removed in a scenario outside those considered in design, and the pier 70 with only one column 72 remaining would collapse following such a damage event. Also, the bridge girders 76 and their connections (e.g., splices) are designed assuming that they would resist the tributary loading and will be supported by the pier cap 74. The girders 76 or the connections resulting from this design process are not verified to be capable of spanning in case the pier 70 support is accidentally removed or if a girder 76 is completely damaged. Further, the transverse cross frames 78 are not designed to be capable of resisting the shock and the new demand levels on them in transferring loads from a damaged girder 76 incapable of spanning to the surviving girders 76. In conventional practice, as the structure is not specifically designed for such events, it is likely that the structure will enter a progressive collapse mode when faced with such a damage scenario due to structural instability or the initiation of progressive failure of more components and resulting chain reactions following the initial damage event.

The application of resiliency design method (including the knowledge base, the resiliency analysis module and the suggestive and prototype proven structural system layouts) will likely result in a resilient structural layout and design shown in FIG. 17 with three columns of smaller diameter also meets the resilient design criteria in addition to the conventional. The three-column pier 70, in addition to resisting conventional loads, is also designed not to collapse if any column 72 is completely removed accidentally. The remaining columns 72 and the cap beam 74 supporting the bridge girders have been verified to be capable of resisting the shock effect as well as the structural demand resulting from such an unforeseen event. Further, the girders 76 and their connections including the transverse framing 78 and their connections have been verified to be capable of resisting shock effects and the structural demand resulting from complete damage to one or more girders 76 as the particular resiliency parameters chosen, and are also verified against the shock and structural demand resulting from a potential event that the pier 70 is completely removed.

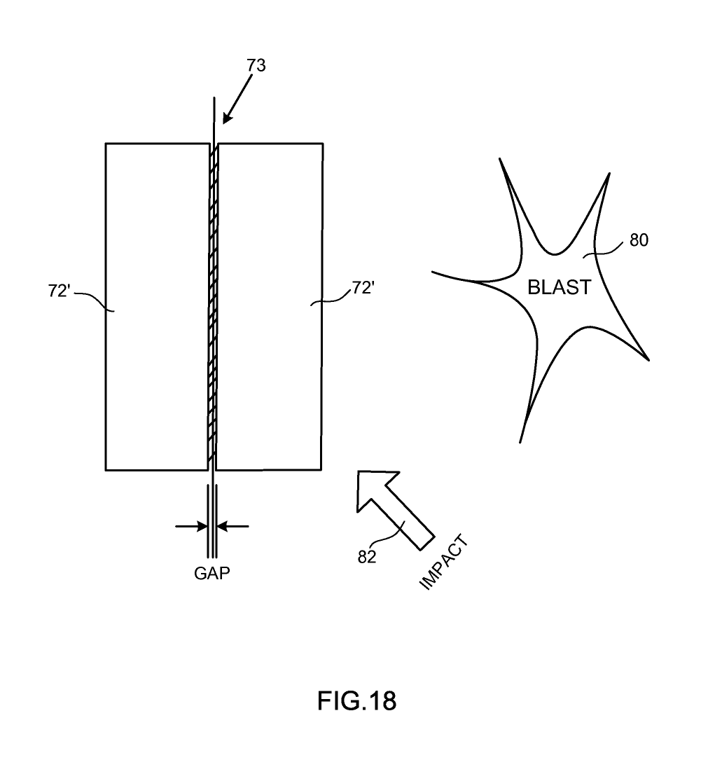

The columns 72 in FIGS. 16 and 17 may also be detailed differently to increase their resiliency as a member against such hazards as impact, blast, fire and other hazard effects are enhanced than with a traditional design. One potential method is shown schematically in FIG. 18 where in lieu of traditional column design, the column cross section is split into two or more sections 72′ with a gap or filler 73 in between the sections so that the effect (e.g., impact) 82 of the hazard (e.g., a blast) 80 is more likely to only impart partial damage and is less likely to damage or breach the entire column section. This type of approach has other benefits such as increasing column ductility and reducing seismic hazard demands on the structure as well.

The resilient design methodology is not merely adding members to a structural system, but involves a system design where the structural system as a whole (geometry and location of members, member framing and the connections) is specifically designed so it is capable of maintaining structural stability as well as able to continue to function in a damaged state with provisions for safety and security of the occupants and the facility. The outlined resilient design method is expected to result also in systems with more structural efficiency likely resulting in more economical systems to construct and maintain.

As the resiliency analysis and interactive interface module 64 also allows quantification of total construction material quantities and allows user-specified levels of resiliency and extent-of-the-damage scenarios to be considered, the potential cost impacts of selecting a given set of resiliency parameters can be easily seen. In general, the resilient design process produces more-integrated structures with more-evenly distributed structural capacity, and therefore is likely to be more cost effective than conventionally designed structures. However, as the module 64 allows a direct comparison of material usage and cost of the different options, the interactive interface allows rational choices to be made on tradeoffs between cost and selection of the degree of resiliency to be achieved and the related safety parameters.

While the schematic example in FIGS. 16 and 17 is quite simple, it still involves a large number of iterations of various design and layout parameters and member design checks in implementing the resilient aspects of the design. For larger and more complex structures, this process becomes time and cost prohibitive within the contexts of existing analysis and design tools; the tools for redundancy analysis and automation presently discussed are highly advantageous, if not indispensable, for its practical application of this design method for real world applications. Further, these tools will facilitate a close look at the structural survival cases, as shown in FIGS. 7-10, and can help advance the state of practice with respect to structural design for safety and security in multi-hazard environments.

The development of the analysis and automation tools will also allow dissections of the structures surviving significant damage similar to those in FIGS. 7-10. These structures seemingly meet some of the functional criteria of the resilient design will supplement the knowledge base rules for development of resilient systems. The development of the noted analysis and automation tools at least to some partial extent is either useful or essential for development of the knowledge base due to the efficiencies it provides in implementing the particular design method.

The steps of the resilient design methodology, discussed above, can be encoded in software non-transiently stored as machine instructions on a computer-readable medium (e.g., a computer hard drive, compact disc, or memory card) and executable by a computer processor to cause the computer machine to perform the described steps. The process is coupled with the computer-readable storage medium and with input and display mechanisms (e.g., a keyboard and computer monitor) for accepting input and selections from a designer and for displaying output parameters based on the design configurations and modeled variables.

The resilient designs produced by this methodology can then serve as a blueprint, and bridges or other designed structures can actually be built in accordance with the design; and the resulting structure will have a high likelihood of surviving any of a wide variety of damage scenarios that may occur in the real world. These will form the suggestive and prototype proven resilient structural layouts and systems that can be adjusted to specific conditions and re-verified as needed using the resiliency analysis method and the tools described.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/100^{th}, 1/50^{th}, 1/20^{th}, 1/10^{th}, ⅕^{th}, ⅓^{rd}, ½, ¾^{th}, etc. (or up by a factor of 2, 5, 10, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety; and appropriate components, steps, and characterizations from these references optionally may or may not be included in embodiments of this invention. Still further, the components and steps identified in the Background section are integral to this disclosure and can be used in conjunction with or substituted for components and steps described elsewhere in the disclosure within the scope of the invention. In method claims, where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A computerized method for resilient design comprising:
a) accepting user input to establish functional, geometric and load criteria for a structure and its members that meets resiliency design criteria;
b) generating a structure system design including a plurality of members, wherein the design satisfies the resiliency design criteria;
c) evaluating at least one of stability of the structural system design, damage effects within the structural system design and propagation of damage effects within the structural system design, and load redistribution under a plurality of simulated damage events, wherein the integrity of particular members or components of members are compromised in the simulated damage events and evaluating structural stability and safety criteria after the damage events;
d) reconfiguring the structure system design, its geometry, and at least one of member layout and composition to improve its structural stability, residual load resistance, and structural reaction in response to the damage events;
e) iteratively repeating steps (b) through (d) using the reconfigured structure system design; and
f) outputting the structure system design to the user after or during multiple iterations of steps (b) through (d) for construction of a structure in accord with the structure system design.

2. The method of claim 1, wherein the simulated damage events that are iteratively repeated include distinct simulated compromises to the integrity of each of a plurality of the members to iteratively test whether the structure design can retain its structural stability and sufficient residual strength when each of the plurality of members is removed while other members retain their integrity.

3. The method of claim 1, further comprising developing a knowledge base for structure system design, a resiliency module for simulation and evaluation of damage events, and prototype designs made in conjunction with the partial or full development of the knowledge base and resiliency module.

4. The method of claim 3, wherein the knowledge base and at least one of the prototype designs are used in combination with the user input to establish the functional, geometric and load criteria for the structure.

5. The method of claim 1, further comprising providing the user with a summary or listing of material consumption to gauge structural efficiency of the structure system design and its cost competitiveness.

6. The method of claim 1, wherein the structure is a bridge.

7. The method of claim 6, wherein the compromised members include at least one of vertical or inclined support bearings, links, columns towers, cables, hangers, connections, beams, chords, struts, frames and girders.

8. The method of claim 7, wherein the reconfiguration of the structure system design includes revision to at least one of geometry, layout, connectivity, and composition of at least one member in the structure system design.

9. The method of claim 8, wherein the reconfiguration of the structure system design includes adding an additional member.

10. The method of claim 8, wherein the member revised is selected from support bearings, links, columns, towers, cables, hangers, connections, beams, chords, struts, frames and girders.

11. The method of claim 6, wherein the compromised members include at least one selected from support bearings, links, columns, towers, cables, hangers, connections, beams, chords, struts, frames and girders.

12. The method of claim 1, wherein the design reconfiguration includes changing at least one of the following design criteria for at least one member: surface pressure loading capacity, fire resistance, impact resistance, and cutting resistance.

13. The method of claim 1, wherein the design reconfiguration includes changing the composition of at least one member.

14. The method of claim 1, wherein the design reconfiguration includes changing at least one of the size and shape of at least one of the members.

15. The method of claim 1, wherein the design reconfiguration includes changing structural connections between the members.

16. The method of claim 1, wherein the design reconfiguration includes adding at least one hazard mitigation system selected from a dehumidification system, a sprinkler system, a protective coating, a structural shield and a hardening mechanism.

17. The method of claim 1, wherein the structure includes at least one occupancy area for human or vehicular occupancy and the design reconfiguration limits deformation and dynamic response of the occupancy area in response to the damage events.

18. The method of claim 1, wherein the design reconfiguration reduces a likelihood of members impacting due to the damage events.

19. The method of claim 1, further comprising identifying hazards to which the structure may be subjected, wherein the damage events are consequences of the identified hazards.

20. The method of claim 1, wherein the evaluation of load redistribution includes evaluating both static, dynamic forces and damage propagation resulting from the damage event.

21. The method of claim 1, wherein the reconfigured structure system design uses less material than the structure system design before the reconfiguration yet allows the reconfigured structure system design to retain its structural stability after simulated damage events that would cause the pre-reconfigured structure system design to fail.

22. The method of claim 1, wherein the iterative evaluations of the simulated damage events includes establishing at least one envelope encompassing the range of loads experienced by the members with the different damage events.

23. The method of claim 22, wherein the structure system design is reconfigured to enable the structure design to maintain its structural stability or residual capacity across the envelope of loads experienced by members with the different damage events.

24. A computer-readable medium storing non-transitory machine instructions that when executed by a computer processor cause a computer machine to perform the following steps:
a) accepting user input to establish functional, geometric and load criteria for a structure and its members that meets resiliency design criteria;
b) generating a structure system design including a plurality of members, wherein the design satisfies the resiliency design criteria;
c) evaluating at least one of stability of the structural system design, damage effects within the structural system design and propagation of damage effects within the structural system design, and load redistribution under a plurality of simulated damage events, wherein the integrity of particular members or components of members are compromised in the simulated damage events and evaluating structural stability and safety criteria after the damage events;
d) reconfiguring the structure system design, its geometry, and at least one of member layout and composition to improve its structural stability, residual load resistance, and structural reaction in response to the damage events;
e) iteratively repeating steps (b) through (d) using the reconfigured structure system design; and
f) outputting the structure system design to the user after or during multiple iterations of steps (b) through (d) for construction of a structure in accord with the structure system design.
